(19) United States
(12) Patent Application Publication
(10) Pub. No.: US 2006/0145749 A1
(43) Pub. Date: Jul. 6, 2006

(54) Bias circuit having reduced power-up delay

(76) Inventors: Dipankar Bhattacharya, Macungie, PA (US); Makeshwar Kothandaraman, Whitehall, PA (US); John C. Kriz, Palmerton, PA (US); Bernard L. Morris, Emmaus, PA (US); Joseph E. Simko, Whitehall, PA (US)

Correspondence Address: Ryan, Mason & Lewis, LLP, 90 Forest Avenue, Locust Valley, NY, 11560, US

(21) Appl. No.: 11/026,426

(22) Filed: Dec. 30, 2004

(51) Int. Cl. G05F 1/10

(52) U.S. Cl. 327/538

(57) ABSTRACT

A bias circuit includes a reference generator for generating a bias signal at an output of the reference generator. The reference generator is selectively operable a first mode or a second mode in response to a first control signal applied to the reference generator, wherein in the first mode of operation, the reference generator is disabled, and in the second mode of operation, the reference generator is operative to generate the bias signal. The bias circuit further includes a shunt circuit connected to the reference generator. The shunt circuit is configured to provide a source of current to assist in charging the output of the reference generator to a quiescent operating level during the second mode of operation. The shunt circuit, in response to a second control signal applied thereto, is operable for a selected period time after the reference generator transitions from the first mode of operation to the second mode of operation.

### FIELD OF THE INVENTION

The present invention relates generally to electronic circuits, and more particularly relates to bias circuits having reduced power consumption without a significant power-up delay.

### BACKGROUND OF THE INVENTION

Bias circuits for generating a substantially fixed reference voltage and/or current are well known. In certain applications employing such bias circuits, particularly those applications involving portable devices, including wireless handsets, notebook computers and personal digital assistants (PDAs), reducing current consumption is a primary objective in order to extend the operating life of a battery often utilized in these devices. Therefore, it is desirable to minimize current consumption in the bias circuits as much as possible.

Some portable devices may employ input/output (IO) buffer circuitry which runs on two or more different voltage levels. For instance, the IO buffer circuitry utilized with such portable devices may be configured so that a portion of the circuit, such as, for example, an output stage, runs at a higher voltage level (e.g., about 3.3 volts), while another portion of the circuitry, such as, for example, core logic, runs at a substantially lower voltage level (e.g., about 1.0 volt). This difference in voltage levels often necessitates the use of a voltage level translator circuit for interfacing between the multiple voltage levels. Furthermore, each voltage level translator circuit may require a bias circuit for biasing the voltage level translator circuit to a desired quiescent operating point.

It is not uncommon to employ an appreciable number (e.g., hundreds) of buffer circuits for a given application, each buffer circuit including at least one bias circuit. Although various techniques for reducing current consumption in a bias circuit may be known, standard bias circuits typically consume at least some measurable quantity of DC current, and, when multiplied by the large number of bias circuits that are often used in such applications, the overall DC power consumption attributable to these buffer circuits can be undesirably excessive.

One known methodology for reducing current consumption in a bias circuit is to simply turn off power to the bias circuit during periods (e.g., a power-down mode) in which the bias circuit is not being utilized. In such instances, an output of the bias circuit is typically held at one of the voltage supply rails, such as ground. However, particularly for substantially low-power bias circuits (e.g., microamperes), there is typically a considerable time delay once the bias circuit is turned on again while the output of the bias circuit charges up to its steady state value. The lower the quiescent current at which the bias circuit operates, the longer the delay. This time delay, which may be referred to herein as power-up delay, is often unacceptable for certain applications.

There exists a need, therefore, for an improved bias circuit having reduced power consumption that does not suffer from one or more of the problems exhibited by conventional bias circuits.

### SUMMARY OF THE INVENTION

The present invention meets the above-noted need by providing, in an illustrative embodiment, techniques for reducing current consumption in a bias circuit without significantly increasing a power-up delay of the bias circuit. The bias circuit is preferably operable in a power-down mode, wherein DC current in the circuit is substantially reduced to zero in response to a control signal applied thereto. In order to reduce power-up delay, the bias circuit includes a shunt circuit which is only operable for a brief period of time (e.g., less than about one microsecond), so as to assist in charging an output of the bias circuit to its steady state value during a normal operating mode. The bias circuit is particularly well-suited for use, for example, in a voltage level translator circuit, although the techniques of the present invention can be extended to essentially any application in which it is desirable to reduce power consumption without increasing power-up delay.

In accordance with one aspect of the invention, a bias circuit includes a reference generator for generating a bias signal at an output of the reference generator. The reference generator is selectively operable in a first mode or a second mode in response to a first control signal applied to the reference generator, wherein in the first mode of operation, the reference generator is disabled, and in the second mode of operation, the reference generator is operative to generate the bias signal. The bias circuit further includes a shunt circuit connected to the reference generator. The shunt circuit is configured to provide a source of current to assist in charging the output of the reference generator to a quiescent operating level during the second mode of operation. The shunt circuit is operable for a selected period time after the reference generator transitions from the first mode of operation to the second mode of operation in response to a second control signal applied to the shunt circuit.

In accordance with another aspect of the invention, a voltage level translator circuit for translating an input signal referenced to a first voltage supply to an output signal referenced to a second voltage supply includes an input stage for receiving the input signal, a latch circuit operative to store a signal representative of a logical state of the input signal, and a voltage clamp operatively connected between the input stage and the latch circuit. The input stage includes at least one transistor device having a first threshold voltage associated therewith and the latch circuit includes at least one transistor device having a second threshold voltage associated therewith, the second threshold voltage being greater than the first threshold voltage. The voltage clamp is configured to limit a voltage across the input stage based, at least in part, on a bias signal applied to the voltage clamp. The voltage level translator circuit further includes a bias circuit selectively operable in at least a first mode or a second mode in response to a control signal applied to the bias circuit. In the first mode of operation, the bias circuit is disabled, and in the second mode of operation, the bias circuit is operative to generate the bias signal. The bias circuit is configured to reduce a transition time delay between the first and second modes of operation.

These and other features and advantages of the present invention will become apparent from the following detailed description of illustrative embodiments thereof, which is to be read in connection with the accompanying drawings.

### BRIEF DESCRIPTION OF THE DRAWINGS

FIG. 1 is a schematic diagram depicting an exemplary voltage level translator circuit in which the methodologies of the present invention are implemented.

FIG. 2A is a functional block diagram depicting an illustrative bias circuit suitable for use with the voltage level translator circuit shown in FIG. 1.

FIG. 2B is a schematic diagram depicting one implementation of the bias circuit shown in FIG. 2A.

FIG. 3 is a schematic diagram illustrating an exemplary bias circuit suitable for use with the voltage level translator circuit shown in FIG. 1, formed in accordance with one embodiment of the present invention.

FIG. 4 is a graphical illustration depicting exemplary signal waveforms corresponding to the bias circuit shown in FIG. 3.

FIG. 5 is a graphical illustration depicting exemplary signal waveforms relating to the voltage level translator circuit shown in FIG. 1 and the bias circuits shown in FIGS. 2B and 3.

### DETAILED DESCRIPTION OF THE INVENTION

The present invention will be described herein in the context of illustrative bias circuits. It should be understood, however, that the present invention is not limited to these or any other particular bias circuit arrangements. Rather, the invention is more generally applicable to techniques for reducing DC current consumption in a bias circuit without significantly increasing power-up delay in the bias circuit. Furthermore, although described herein in the context of a voltage level translator circuit application, the techniques of the present invention may be extended to essentially any application requiring a bias circuit having reduced current consumption and without any significant power-up delay. Although implementations of the present invention are described herein with specific reference to P-type metal-oxide semiconductor (PMOS) and N-type metal-oxide semiconductor (NMOS) transistor devices, as may be formed using a complementary metal-oxide semiconductor (CMOS) fabrication process, it is to be appreciated that the invention is not limited to such transistor devices and/or to such a fabrication process, and that other suitable devices, such as, for example, bipolar junction transistors, etc., and/or fabrication processes (e.g., bipolar, BiCMOS, etc.), may be similarly employed, as will be understood by those skilled in the art.

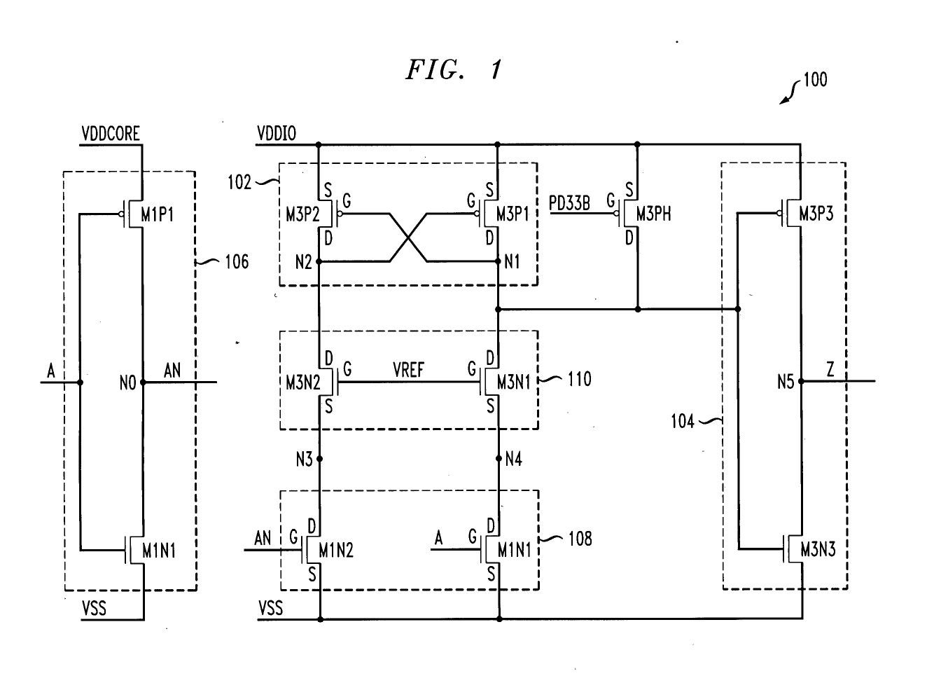

With reference to FIG. 1, an exemplary voltage level translator circuit 100 is shown in which the techniques of the present invention can be implemented. The voltage level translator circuit 100 can be used to translate input signals (e.g., signals A and AN) referenced to a lower core supply voltage, such as, for example, VDDCORE, to an output signal Z which is referenced to a higher supply voltage, such as, for example, VDDIO. In many applications, the lower core supply voltage VDDCORE is typically about 1.0 volt and the higher supply voltage VDDIO is typically about 3.3 volts. It is to be appreciated, however, that the present invention is not limited to these or to any particular voltage levels for VDDCORE and VDDIO. Furthermore, the techniques of the present invention may be similarly employed in a voltage level translator circuit configured to translate an input signal referenced to the higher supply voltage VDDIO to an output signal referenced to the lower core supply voltage VDDCORE, as will be understood by those skilled in the art.

Exemplary voltage level translator circuit 100 comprises a latch circuit 102 including a pair of high voltage PMOS transistors M3P1 and M3P2, each transistor having a source terminal connected to the positive voltage supply VDDIO, and having a gate terminal of one transistor connected to a drain terminal of the other transistor in a cross-coupled arrangement. Specifically, the gate terminal of M3P1 is connected to the drain terminal of M3P2 at node N2, and the gate terminal of M3P2 is connected to the drain terminal of M3P1 at node N1. Because latch circuit 102 includes two nodes, namely, node N1 and N2, the latch circuit may be referred to as a differential latch. It is to be understood, however, that alternative latch circuitry may be similarly used, as will be known by those skilled in the art. The cross-coupled arrangement of transistors M3P1 and M3P2 in latch circuit 102 essentially provides a mechanism for storing a signal representative of the logical state of input signal AN at node N1.

It is to be appreciated that, because an MOS device is symmetrical in nature, and thus bidirectional, the assignment of source and drain designations in the MOS device is essentially arbitrary. Therefore, the source and drain terminals may be referred to herein generally as first and second source/drain terminals, respectively, where the term “source/drain” in this context denotes a source terminal or a drain terminal.

An output signal of the latch circuit 102 at node N1 preferably drives an output stage 104 for buffering the output signal stored in the latch circuit and for generating a buffered output signal (e.g., signal Z) of the voltage level translator circuit having substantially rail-to-rail (e.g., VSS to VDDIO) logic levels. Output stage 104 is preferably configured so as to provide an output signal Z which has a logic state that corresponds to the logic state of the input signal A, although such a correspondence between the output signal and the input signal is not a requirement of the invention. Thus, it is to be understood that while output stage 104 is shown as generating an output signal Z that is a logical inversion of the signal at node N1, the output stage need not provide an inversion function.

The output stage 104 preferably has an input coupled to node N1 and an output at node N5 for generating the output signal Z based on at least one of the input signals A and AN. The output stage 104 comprises PMOS transistor M3P3 and NMOS transistor M3N3 configured as a standard inverter, although alternative circuit configurations are similarly contemplated by the invention. Specifically, a source terminal of M3P3 is connected to VDDIO, and a source terminal of M3N3 is connected to VSS. Gate terminals of transistors M3P3 and M3N3 are connected together to form the input of output stage 104 at node N1, and drain terminals of M3P3 and M3N3 are connected together to form the output of the voltage level translator circuit 100 at node N5.

Input signal AN is a logical inversion of input signal A, such that when signal A is a logic high level, signal AN is a logic low level, and vice versa. Transistors forming core logic circuitry used to generate the input signals A and AN, such as, for example, transistors M1PA and M1NA in inverter 106, are commonly low voltage transistors. Traditional mixed signal integrated circuit processes typically offer both high voltage and low voltage transistor devices. The high voltage devices generally have a nominal threshold voltage of about 0.75 volts and are intended to operate with the higher supply voltage VDDIO (e.g., about 3.3 volts). The low voltage devices have a nominal threshold voltage which is substantially lower than the high voltage devices, such as, for example, about 0.35 volts, and are intended to operate with the lower core supply voltage VDDCORE (e.g., about 1.0 volt).

The voltage level translator circuit 100 includes an input stage 108 including a pair of low voltage NMOS transistors M1N1 and M1N2. Conventional voltage level translator circuits may employ an input stage comprising high voltage NMOS transistors in place of low voltage transistors M1N1 and M1N2. A primary disadvantage of using high voltage NMOS devices in the input stage is that, under certain PVT conditions, such as, for example, when the temperature is low (e.g., about zero degrees Celsius), the threshold voltages of the input transistors may be high, such as about 0.8 volt or higher, which is only about one tenth of a volt or less below a minimum voltage limit of the lower core supply VDDCORE (e.g., about 0.9 volt) to which input signal A is referenced. Due to voltage drops internal to the circuit, the actual voltage seen by the input stage devices could be even lower. With less than about one tenth of a volt of overdrive, the high voltage input stage transistors will be unacceptably slow and may even fail to turn on entirely, thus rendering the conventional voltage level translator circuits unreliable and/or inoperable. As previously stated, low voltage transistors typically have a nominal threshold voltage which is substantially lower than the nominal threshold voltage of high voltage transistors, thus providing more overdrive compared to high voltage devices. The additional few tenths of a volt of overdrive obtained by using low voltage devices is sufficient to ensure that the voltage level translator circuit 100 remains operable over a much larger range of PVT variations compared to standard voltage level translator circuits.

In order to avoid damaging the low voltage input devices M1N1 and M1N2 in input stage 108, however, the voltage appearing across any two terminals of transistors M1N1 and M1N2 should be clamped, for example, to less than an upper limit of the lower core supply VDDCORE, typically about 1.26 volts. Since nodes N1 and N2 can be pulled up to the higher supply voltage VDDIO, which is nominally about 3.3 volts, a voltage clamp 110 is added between the input stage 108 and the latch circuit 102. Specifically, voltage clamp 110 preferably includes a pair of high voltage NMOS transistors M3N1 and M3N2. Source terminals of transistors M1N1 and M1N2 are preferably connected to VSS, a drain terminal of M1N1 is connected to a source terminal of M3N1 at node N4, and a drain terminal of M1N2 is connected to a source terminal of transistor M3N2 at node N3. A drain terminal of M3N1 is connected to the drain terminal of transistor M3P1 at node N1, and a drain terminal of M3N2 is connected to the drain terminal of transistor M3P2 at node N2.

Gate terminals of M3N1 and M3N2 are preferably connected to a common reference voltage VREF for biasing M3N1 and M3N2 to a desired operating point so as to limit the voltage appearing across devices M1N1 and M1N2, respectively. For most PVT conditions and for low speed applications (e.g., less than about 100 MHz), it may be sufficient to use the lower core supply VDDCORE as the reference voltage VREF. Since these devices do not switch on and off, one tenth of a volt of overdrive is generally acceptable to keep the devices turned on. However, in order to satisfy all desired PVT conditions, devices M3N1 and M3N2 may be required to be sized significantly large, and the voltage level translator circuit 100 may fail to operate reliably even for a moderate speed of about 200 MHz.

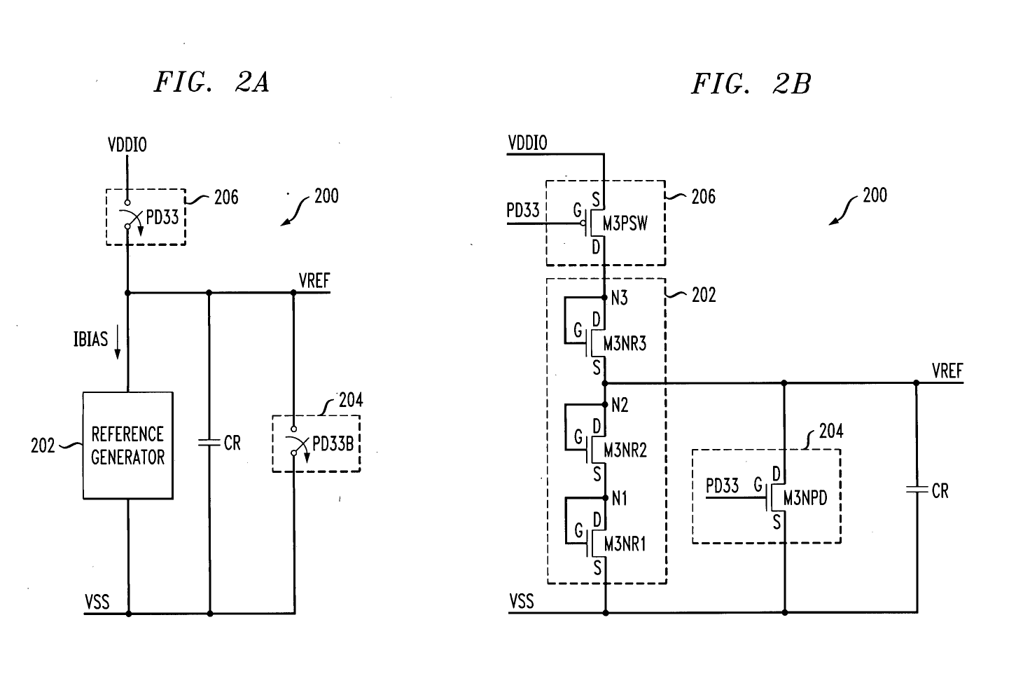

One solution to this problem is to employ a bias circuit adapted to generate a reference voltage VREF which is slightly higher than VDDCORE to provide ample overdrive for devices M3N1 and M3N2 in voltage clamp 110. An illustrative bias circuit 200 suitable for use with the voltage level translator circuit 100 is depicted in FIGS. 2A and 2B. FIG. 2A shows a functional block diagram of the bias circuit 200, and FIG. 2B shows an exemplary implementation of the bias circuit. As apparent from the figures, bias circuit 200 preferably includes a reference generator 202 for generating the voltage VREF which, as previously stated, is slightly higher than VDDCORE, for biasing the voltage clamp 110 at a desired operating point. A first terminal of the reference generator 202 is preferably connected to VSS, and a second terminal of the reference generator is selectively connectable to VDDIO through a first switch 206, or alternative switching arrangement (e.g., a multiplexer, etc.). In a preferred embodiment of the invention, switch 206 comprises a high voltage PMOS transistor M3PSW having a source terminal connected to VDDIO, a drain terminal connected to the reference generator, and a gate terminal for receiving a control signal PD33 applied thereto.

The reference generator 202, in an illustrative embodiment thereof, may comprise a voltage divider circuit configured to divide the supply voltage VDDIO down to a potential VREF that is suitable for biasing the voltage clamp 110 to a desired operating point (e.g., about 1.5 volts). For example, reference generator 202 may include a plurality of stacked high voltage NMOS transistor devices M3NR1, M3NR2 and M3NR3, each device being connected in a diode configuration, as shown in FIG. 2B. Specifically, a source terminal of M3NR1 is connected to VSS, and gate and drain terminals of M3NR1 are connected together at node N1. A source terminal of M3NR2 is connected to node N1, and gate and drain terminals of M3NR2 are connected together at an output node N2 for generating the voltage VREF. A source terminal of M3NR3 is connected to node N2, and gate and drain terminals of M3NR3 are connected together at node N3. This circuit arrangement may be referred to as a threshold voltage divider, since the reference voltage generated by the reference generator will be based primarily on the respective threshold voltages of the NMOS devices M3NR1, M3NR2, M3NR3. It is to be understood that the reference generator 202 is not limited to the specific number or configuration of the NMOS devices M3NR1, M3NR2, M3NR3 shown. Rather, the number of devices in the stacked diode arrangement of reference generator 202 may be adjusted depending on the supply voltage VDDIO used, the desired reference voltage VREF, and/or certain characteristics associated with the devices (e.g., threshold voltage, temperature, etc.).

The diode-connected transistor devices M3NR1, M3NR2, M3NR3 can be represented as respective resistances. The resistance of a given device will be primarily a function of a size of the device (e.g., a W/L ratio, where W is a width of a channel in the device and L is a length of the channel). Thus, the reference voltage VREF may be adjusted by appropriately sizing the devices M3NR1, M3NR2, M3NR3. Generally, the larger the channel length of the device relative to the channel width, and thus the smaller the W/L ratio of the device, the larger the resistance of the device. Assuming devices M3NR1, M3NR2 and M3NR3 are of substantially equal size relative to one another, the voltage VREF appearing at node N2 will be approximately two diode drops above VSS (e.g., about 1.5 volts). While the reference generator 202 is depicted in FIG. 2B as comprising a simple voltage divider, it is to be understood that the reference generator may be implemented using alternative circuit arrangements, including, but not limited to, a bandgap reference, etc., as will be understood by those skilled in the art.

A filter capacitor CR is preferably connected between output node N2 of the bias circuit 200 and the negative voltage supply VSS to help filter out any high frequency components that may be present in the reference voltage VREF generated by the bias circuit. Capacitor CR is preferably chosen to be about 0.3 picofarad (pF), although the invention is not limited to any specific capacitor value. Moreover, a current IBIAS in the bias generator circuit 200 and the capacitor CR may be scaled up or down in proportion to the required speed of operation of the voltage level translator circuit 100 in which the bias generator circuit 200 may be employed.

The DC current IBIAS in the bias circuit 200 is preferably reduced to a substantially low level (e.g., about a few microamperes), for example, by making the channel length of transistor M3PSW in switch 206 substantially large, thus making the corresponding resistance associated with M3PSW substantially high in value (e.g., greater than about 100 kilo ohms). The corresponding resistance of transistors M3NR1, M3NR2, M3NR3 in the reference generator 202 can also be made high (e.g., greater than 100 kilo ohms) by appropriately sizing these devices, as previously stated. In order to further reduce the current IBIAS in the bias circuit 200, resistance can be added in series between VDDIO and node N2 as needed.

While the overall resistance of a path between VDDIO and VSS, comprising devices M3PSW, M3NR1, M3NR2, M3NR3, can be made sufficiently high so as to minimize the DC current IBIAS consumed in the bias circuit 200 (e.g., a few microamperes), the amount of integrated circuit chip area required to fabricate these devices can be significant. Furthermore, in certain applications, there may be hundreds of bias circuits employed in a given integrated circuit device. Therefore, the overall DC current consumption attributable to the bias circuits can become quite significant. Because of the large number of bias circuits that may be employed for a given application, it is advantageous to reduce the DC current in the bias circuit 200 by even the slightest amount.

Accordingly, bias circuit 200 is preferably selectively operable in one of at least two modes, namely, a first mode, which is preferably a power-down mode, and a second mode, which is preferably a normal (e.g., power-on) operating mode. In the power-down mode of operation, the bias circuit 200 is preferably disabled, such as, for example, by opening switch 206 in response to an active control signal PD33. By way of example only, when control signal PD33 is a logic high, such as in the power-down mode, device M3PSW will be turned off, thereby electrically isolating the reference generator 202 from VDDIO and essentially shutting off all current in the bias circuit 200. Likewise, when signal PD33 is a logic low, such as in a normal operating mode, M3PSW will be turned on, thereby connecting the reference generator 202 to VDDIO. Control signal PD33 may be externally generated, such as, for example, by digital power control logic (not shown), although PD33 may alternatively be generated within the voltage level translator circuit 100.

When switch 206 is open, node N2, and thus the voltage VREF, may be undefined. In order to reduce the likelihood of damage to the low voltage devices M1N1, M1N2 comprised in the input stage 108 of voltage level translator circuit 100 (e.g., as a result of node N2 drifting above an acceptable operating level), a second switch 204 is preferably included in the bias circuit 200. Switch 204 may be used for selectively setting the reference voltage VREF generated at node N2 to a known level, which may be VSS or an alternative reference source, in response to a second control signal applied to the second switch. The second control signal, which may be a logical complement of the first control signal PD33, namely, PD33B depending on the configuration of the second switch 204, preferably enables the second switch whenever the first switch 206 is disabled, such as, for example, in the power-down mode of operation. With VREF set to VSS, current consumed in the voltage level translator circuit 100 is effectively reduced to zero, since voltage clamp devices M3N1 and M3N2 will be turned off, thereby disabling the voltage level translator circuit.

Switch 204 preferably comprises a high voltage NMOS transistor M3NPD having a source terminal connected to VSS, a drain terminal connected to node N2, and a gate terminal for receiving the second control signal. Alternative switching circuitry may be similarly employed (e.g., a multiplexer, etc.), as will be known by those skilled in the art. Since an NMOS transistor is preferably used to implement the second switch 204, which is opposite in polarity to device M3PSW comprised in switch 206, control signal PD33 may also be utilized as the second control signal. By way of example only, during the power-down mode, control signal PD33 will be a logic high, thereby turning off transistor M3PSW in first switch 206 and disabling bias circuit 200. Control signal PD33 being a logic high turns on transistor M3NPD in the second switch 204, thereby pulling node N2 to VSS and disabling the voltage level translator circuit 100. In this manner, DC current consumed by the bias circuit 200 is essentially reduced to zero.

When the voltage level translator circuit 100 is disabled, as may be the case during a power-down mode of operation, the voltage at node N1 in the voltage level translator circuit may float to an undetermined level, thereby causing the circuit 100 to consume significant DC current, primarily through an electrical path established between VDDIO and VSS via transistors M3P3 and M3N3 in output stage 104. Alternatively, if the voltage at node N1 floats to one of the voltage supply rails (e.g., VDDIO or VSS), the output signal Z generated by the voltage level translator circuit 100 may produce an erroneous logic state. In either case, however, the logical state of the output signal Z is indeterminate.

In order to reduce the likelihood that node N1 will float to some intermediate voltage level when the voltage level translator circuit 100 is disabled, the voltage level translator circuit preferably includes a transistor, or alternative switching circuitry, connected between node N1 and a voltage supply (e.g., VDDIO or VSS) which is preferably gated by the same control signal (or a logical complement thereof) used to disable the bias circuit 200, namely, PD33. In a preferred embodiment of the invention, the voltage level translator circuit 100 includes a high voltage PMOS device M3PH having a source terminal connected to VDDIO, a drain terminal connected to node N1, and a gate terminal for receiving a logic complement of control signal PD33, namely, signal PD33B. Alternatively, a high voltage NMOS device (not shown) may be employed having a source terminal connected to VSS, a drain terminal connected to node N1, and a gate terminal for receiving control signal PD33. It is to be appreciated that alternative circuitry for defining the output of the voltage level translator circuit 100 may be used, as will become apparent to those skilled in the art.

By way of example only, and without loss of generality, a basic operation of the voltage level translator circuit 100 will be described. During a normal mode of operation (e.g., when control signal PD33 is low), when input signal A is a logic high, transistor M1N1 will turn on, thereby pulling node N4 low. Signal AN, being a complement of signal A, will be a logic low, thereby turning off transistor M1N2 and allowing node N3 to float. This causes transistor M3N1 to turned on harder than transistor M3N2, thereby pulling node N1 low and turning on transistor M3P2. Transistor M3P2 being turned on will pull node N2 high, thereby turning off transistor M3P1 and latching the state of input stage 108. Node N1 being low forces output signal Z to a logic high. Similarly, when signal A is low, transistor M1N1 is turned off, allowing node N4 to float. Signal AN, being a complement of signal A, will be high, thereby turning on transistor M1N2 and pulling node N3 low. This causes transistor M3N2 to be turned on harder than M3N1, thereby pulling node N2 low and turning on transistor M3P1. Transistor M3P1 being turned on pulls node N1 high, thereby turning off transistor M3P2 and forcing output signal Z to be low.

As previously described, the bias circuit, for generating reference voltage VREF for biasing the voltage clamp 110 to a desired operating point, is preferably operative in a power-down mode when control signal PD33 is high. During the power-down mode of operation, substantially all current in the voltage level translator circuit 100 and bias circuit 200 is turned off, advantageously reducing power consumption. However, when the control signal PD33 transitions from high to low, thereby initiating a change in the operating mode of the bias circuit 200 and voltage level translator circuit 100 to a normal operating mode, there may be a considerable delay (e.g., greater than about 100 nanoseconds (ns)) before the output signal Z of the voltage level translator circuit 100 is fully defined. This delay, which as previously stated may be referred to as a power-up delay, is due at least in part to the fact that in the bias circuit 200, node N2 requires a considerable amount of time to charge up from VSS to its quiescent operating level. Moreover, the amount of time required for node N2 to charge to its steady state value is, to a large extent, a function of the DC current IBIAS in the bias circuit 200. Therefore, as the current IBIAS is reduced, as is desirable in order to minimize overall current consumption, the power-up delay in the bias circuit 200, and thus the voltage level translator circuit 100, will increase accordingly.

By way of example only, with reference again to FIG. 2B, when control signal PD33 transitions from a logic high, as in a power-down mode, to a logic low, for a normal mode of operation, device M3PSW in bias circuit 200 turns on and device M3NPD turns off, allowing capacitor CR to charge. Voltage VREF at node N2 will begin ramping up at a rate equal to a resistor-capacitor (RC) time constant of the charging path comprising transistor M3PSW, which is substantially high in impedance (e.g., several hundred kilo ohms) in order to limit the DC current IBIAS in the bias circuit 200, transistor M3NR3, and capacitor CR, which is preferably on the order of about 0.3 pF. The amount of time it takes VREF to reach its steady state value can exceed 300 nanoseconds or more. For certain applications, this delay is not acceptable. One way to solve this problem is to modify bias circuit 200, as will be described in further detail below.

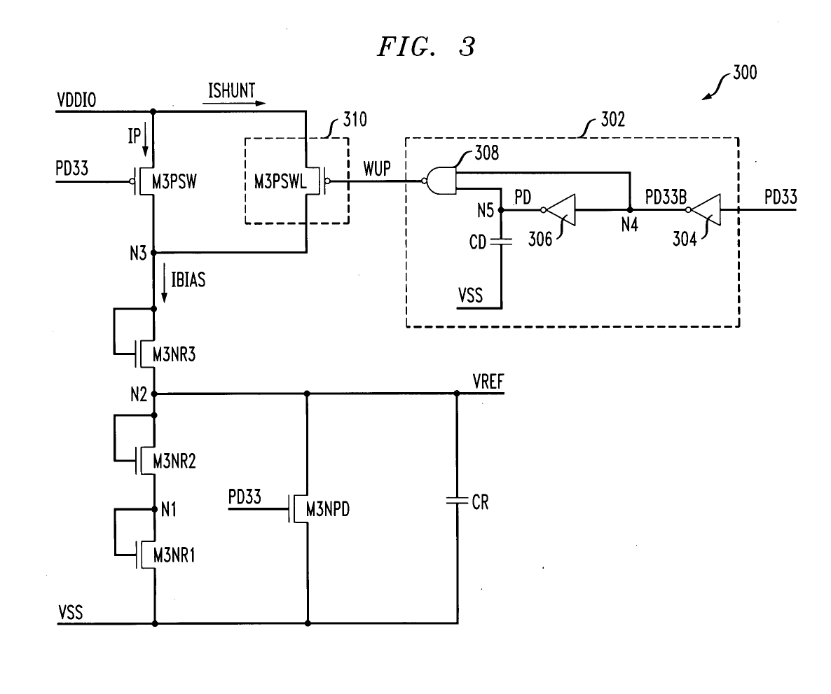

FIG. 3 is a schematic diagram depicting an exemplary bias circuit 300, formed in accordance with an illustrative embodiment of the invention. The exemplary bias circuit 300 is advantageously configured so as to at least temporarily provide a low resistance path for reducing the amount of time necessary to charge node N2 to its steady state value, thereby substantially eliminating power-up delay in the voltage level translator circuit 100 in which the bias circuit 300 may be utilized. The exemplary bias circuit 300, like bias circuit 200 shown in FIG. 2B, preferably comprises a voltage divider including three stacked high voltage NMOS devices M3NR1, M3NR2, M3NR3 connected in a diode configuration to generate bias voltage VREF. Additionally, a high voltage PMOS device M3PSW, or alternative switching arrangement, is preferably connected between VDDIO and the voltage divider at node N3, with M3PSW being gated by power down signal PD33, as in bias circuit 200. Device M3PSW is preferably substantially high in impedance (e.g., several hundred kilo ohms) in order to limit the DC current IBIAS consumed in the bias circuit 300. The bias circuit 300 also includes a high voltage NMOS device M3NPD connected between node N2 and VSS for selectively pulling down node N2 to VSS in response to signal PD33. Alternative circuitry for defining the output of the bias circuit 300 is similarly contemplated, as will be understood by those skilled in the art.

In order to reduce the charging time necessary for node N2 to reach its steady state value, bias circuit 300 preferably includes a shunt circuit 310 that is selectively connectable between VDDIO and node N3 for providing a substantially low resistance path (e.g., less than about ten ohms) between VDDIO and node N3. The shunt circuit 310 may comprise, for example, a high voltage PMOS device M3PSWL having a source terminal connected to VDDIO, a drain terminal connected to node N3, and a gate terminal for receiving a control signal WUP applied thereto. Transistor M3PSWL is preferably sized so that its on-resistance is substantially low, such as, for example, less than about ten ohms. When control signal WUP is active (e.g., logic low), transistor M3PSWL is turned on. Node N2 will initially be at the potential of VSS (e.g., zero volt), as will node N3. Therefore, a large current ISHUNT will begin to flow through device M3PSWL, which will be approximately equal to VDDIO divided by the impedance of M3PSWL, to rapidly charge node N2.

The shunt current ISHUNT is only required for a short duration of time, such as, for example, several nanoseconds. Consequently, control signal WUP is preferably generated by a pulse generator 302 included in bias circuit 300. The duration of time during which the shunt circuit 310 is active can be controlled as a function of a pulse width of the control signal WUP generated by the pulse generator 302. It is to be understood that the invention is not limited to a particular duration of time during which the shunt circuit 310 is active, nor is the invention limited to the particular pulse generator circuit configuration shown.

In a preferred embodiment of the invention, the pulse generator 302 comprises a one-shot pulse circuit including a first inverter 304 having an input for receiving control signal PD33 and an output connected to node N4, a second inverter 306 having an input connected to node N4 and an output connected to node N5, and a NAND gate 308 having a first input connected to node N4, a second input connected to node N5 and an output for generating control signal WUP. The output of NAND gate 308 will only be a logic low when the two inputs to the NAND gate at nodes N4 and N5 are a logic high. During steady state (e.g., static) operation, this cannot occur, since the logical state at node N5 will be a complement of the logical state at node N4 as a result of inverter 306 connected between nodes N4 and N5. Dynamically, however, both inputs of NAND gate 308 can be high.

During a momentary period when control signal PD33 transitions from a logic high to a logic low, node N5 will already be high, since the state change does not propagate instantaneously, and node N4 will transition from low to high. Node N5 will remain high only for a short time equal to a propagation delay of inverter 306, generally about one nanosecond or less, before its transition to a logic low. The signal WUP generated by pulse generator 302 will therefore be a low-going pulse having a width that is substantially equal to the propagation delay of inverter 306 (e.g., less than about 1 ns). The period of time during which the output signal WUP remains low can be increased, for example, by adding delay in the signal path between nodes N4 and N5 (e.g., by increasing the propagation delay of inverter 306) or by adding capacitance to node N5. Preferably, the pulse generator 302 includes a capacitor CD connected between node N5 and a reference source, which may be VSS. By adjusting the capacitance value of capacitor CD, the rate at which node N5 changes can be adjusted, thereby controlling the pulse width of signal WUP as desired. In one embodiment of the invention, capacitor CD is chosen to be on the order of a few hundred femtofarads. Since the shunt circuit 310 is not required during the power-down mode of operation, pulse generator 302 is preferably configured such that control signal WUP remains high, thereby keeping the shunt circuit 310 disabled, during a transition from the normal mode of operation to the power-down mode.

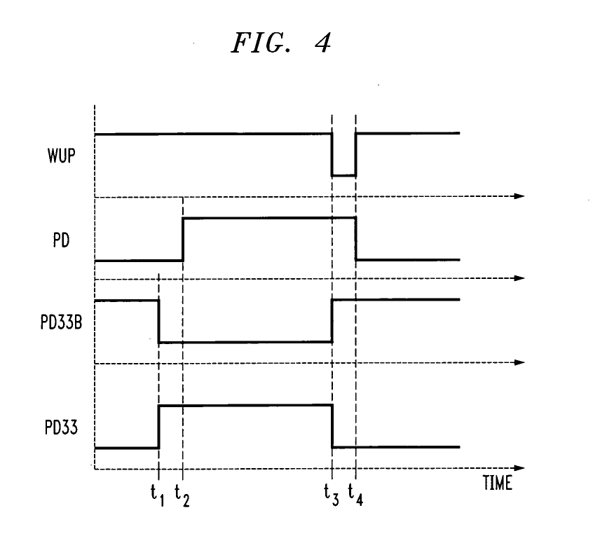

FIG. 4 is a graphical illustration depicting exemplary voltage waveforms relating to the pulse generator 302 shown in FIG. 3. By way of example only, as apparent from the figure, at time t₁, control signal PD33 transitions from low to high, and likewise PD33B, which is a logical complement of signal PD33, transitions from high to low. At time t₂, after a certain delay relative to time t, (e.g., about 2 ns) determined primarily by the value of capacitor CD and the propagation delay of inverter 306, signal PD at node N5 transitions from low to high. During this time, control signal WUP remains high so as to keep shunt circuit 310 in bias circuit 300 disabled. At time t₃, signal PD33 transitions from high to low and signal PD33B transitions from low to high, thereby initiating a return to the normal operating mode. The period of time between t₃ and t₂ is preferably long enough such that the nodes in bias circuit 300 have substantially reached their steady state levels. At time t₃, control signal WUP also goes low, since signal PD at node N5 remains high. At time t₄, signal PD goes low, thereby forcing control signal WUP high. The delay between times t₄ and t₃ will be substantially the same as the delay between times t₂ and t₁.

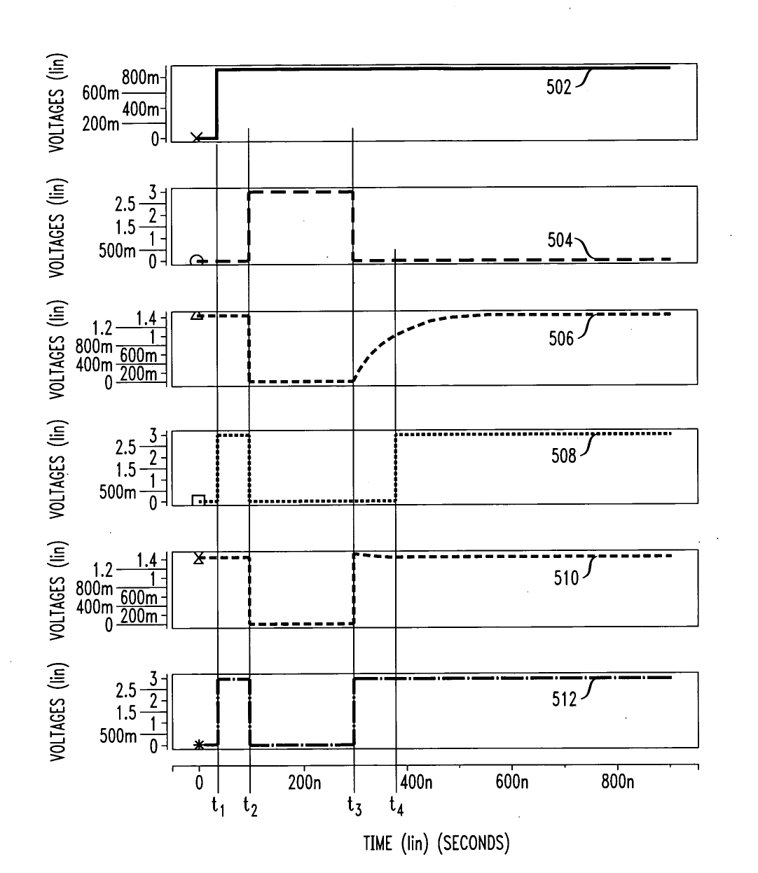

By way of example only, FIG. 5 is a graphical illustration depicting exemplary waveforms relating to the voltage level translator circuit 100 shown in FIG. 1. Waveform 502 represents the input signal A presented to the illustrative voltage level translator circuit 100, waveform 504 represents the control signal PD33 used to initiate the power-down mode, waveform 506 represents the output VREF of bias circuit 200, waveform 508 represents the output signal Z of voltage level translator 100 employing bias circuit 200, waveform 510 represents the output signal VREF of improved bias circuit 300 (including the shunt circuit 310 and pulse generator 302), and waveform 512 represents the output signal Z of the voltage level translator circuit 100 employing bias circuit 300.

At time t1 (e.g., about 50 ns), input signal A goes from low to high and remains high for the duration of the simulation, as depicted by waveform 502. Signal A going high forces the output signal Z of the voltage level translator circuit 100 high with no significant delay, regardless of the bias circuit used, as shown by waveforms 508 and 512. During this time, control signal PD33 is low, indicating a normal operating mode, and VREF is high regardless of the bias circuit used, as shown in waveforms 504, 506 and 510, respectively.

At time t2 (e.g., about 100 ns), control signal PD33 goes high, initiating a power-down mode, thereby forcing VREF low and the output signal Z low, regardless of the bias circuit used. At time t3 (e.g., about 300 ns), control signal PD33 transitions from high to low, initiating a return to the normal operating mode. When using bias circuit 200, VREF must charge from VSS to its steady state value through a high impedance switch 206 (see FIG. 3), as previously described. Consequently, signal VREF will have a considerable charging period associated therewith, as shown by waveform 506. As a result of this extended charging period, the output signal Z of the voltage level translator circuit 100 does not change until time t4 (e.g., about 380 ns), resulting in a power-up delay of about 80 ns using bias circuit 200, as shown by waveform 508.

By contrast, using the improved bias circuit 300, the output signal VREF of the bias circuit 300 charges to its steady state value without any significant delay as a result of the shunt circuit 310, as shown by waveform 510. Therefore, the output signal Z of the voltage level translator circuit 100 employing bias circuit 300 exhibits no significant power-up delay, as shown by waveform 512.

The techniques of the present invention described herein are advantageous for reducing a power-up delay of a voltage level translator circuit when transitioning from a power-down mode to a normal mode of operation. Moreover, the techniques of the present invention can be beneficially extended to reduce power-up delay in essentially any analog reference generator circuit, particularly reference generator circuits operating at substantially small quiescent current levels, as is often desirable in applications where minimizing current consumption is critical (e.g., portable devices).

At least a portion of the voltage level translator circuit and/or bias circuit of the present invention may be implemented in an integrated circuit. In forming integrated circuits, a plurality of identical die are typically fabricated in a repeated pattern on a surface of a semiconductor wafer. Each die includes a device described herein, and may include other structures or circuits. The individual die are cut or diced from the wafer, then packaged as an integrated circuit. One skilled in the art would know how to dice wafers and package die to produce integrated circuits. Integrated circuits so manufactured are considered part of this invention.

Although illustrative embodiments of the present invention have been described herein with reference to the accompanying drawings, it is to be understood that the invention is not limited to those precise embodiments, and that various other changes and modifications may be made therein by one skilled in the art without departing from the scope of the appended claims.

What is claimed is:

1. A bias circuit, comprising:
a reference generator for generating a bias signal at an output of the reference generator, the reference generator being selectively operable in one of at least a first mode and a second mode in response to a first control signal applied to the reference generator, wherein in the first mode of operation, the reference generator is disabled, and in the second mode of operation, the reference generator is operative to generate the bias signal; and
a shunt circuit connected to the reference generator, the shunt circuit being configured to provide a source of current to assist in charging the output of the reference generator to a quiescent operating level during the second mode of operation, the shunt circuit, in response to a second control signal applied thereto, being operable for a selected period time after the reference generator transitions from the first mode of operation to the second mode of operation.

2. The bias circuit of claim 1, further comprising a pulse generator operative to generate the second control signal, the pulse generator being configured to activate the shunt circuit during a transition time between the first and second modes of operation, the period of time during which the shunt circuit is operable being a function of the second control signal.

3. The bias circuit of claim 1, further comprising a one-shot circuit for generating the second control signal, the one shot circuit including:
a first inverter having an input for receiving the first control signal and an output;
a second inverter having an input connected to the output of the first inverter and an output;
a delay element configurable for selectively delaying the output of the second inverter relative to the output of the first inverter; and
a NAND gate having a first input for receiving the output of the first inverter, a second input for receiving the output of the second inverter and an output for generating the second control signal.

4. The bias circuit of claim 1, wherein the shunt circuit comprises a transistor including a first source/drain terminal connected to a positive voltage supply of the bias circuit, a second source/drain terminal connected to the output of the reference generator, and a gate terminal for receiving the second control-signal.

5. The bias circuit of claim 1, wherein the reference generator comprises:
a voltage source adapted for generating the bias signal at the output of the reference generator;
a first switching circuit connected between a positive voltage supply of the bias circuit and the output of the reference generator, the first switching circuit being adapted to selectively disable the reference generator in response to the first control signal; and
a second switching circuit connected to the output of the reference generator, the second switching circuit being adapted to set the output of the reference generator to a known voltage level in the first mode of operation.

6. A voltage level translator circuit for translating an input signal referenced to a first voltage supply to an output signal referenced to a second voltage supply, the circuit comprising:
an input stage for receiving the input signal, the input stage including at least one transistor device having a first threshold voltage associated therewith;
a latch circuit being operative to store a signal representative of a logical state of the input signal, the latch circuit including at least one transistor device having a second threshold voltage associated therewith, the second threshold voltage being greater than the first threshold voltage;
a voltage clamp operatively connected between the input stage and the latch circuit, the voltage clamp being configured to limit a voltage across the input stage based, at least in part, on a bias signal applied to the voltage clamp; and
a bias circuit, comprising:
a reference generator for generating the bias signal at an output of the reference generator, the reference generator being selectively operable in one of at least a first mode and a second mode in response to a first control signal applied to the reference generator, wherein in the first mode of operation, the reference generator is disabled, and in the second mode of operation, the reference generator is operative to generate the bias signal; and
a shunt circuit connected to the reference generator, the shunt circuit being configured to provide a source of current to assist in charging the output of the reference generator to a quiescent operating level during the second mode of operation, the shunt circuit, in response to a second control signal applied thereto, being operable for a selected period time after the reference generator transitions from the first mode of operation to the second mode of operation.

7. The circuit of claim 6, wherein the bias circuit further comprises:
a first switching circuit connected to the reference generator, the first switching circuit being adapted to selectively disable the reference generator in response to the first control signal; and
a second switching circuit connected to the reference generator, the second switching circuit being adapted to set the output of the reference generator to a known logic state in the first mode of operation;
wherein the shunt circuit is adapted to provide a low resistance path between the second voltage supply and the output of the reference generator for decreasing a charging time of the output of the reference generator in response to the second control signal.

8. The circuit of claim 7, wherein the bias circuit further comprises a pulse generator operative to generate the second control signal, the pulse generator being configured to activate the shunt circuit during a transition time between the first and second modes of operation.

9. The circuit of claim 8, wherein the pulse generator comprises a one-shot circuit for generating the second control signal.

10. The circuit of claim 8, wherein the pulse generator comprises:
a first inverter having an input for receiving the first control signal and an output;
a second inverter having an input connected to the output of the first inverter and an output;
a delay element configurable for selectively delaying the output of the second inverter relative to the output of the first inverter; and
a NAND gate having a first input for receiving the output of the first inverter, a second input for receiving the output of the second inverter and an output for generating the second control signal.

11. The circuit of claim 7, wherein the shunt circuit comprises a P-type transistor device having a first source/drain terminal connected to the second voltage supply, a second source/drain terminal connected to the output of the reference generator, and a gate terminal for receiving the second control signal, the transistor device having an impedance associated therewith which is less than an impedance of the first switching circuit.

12. The circuit of claim 6, wherein the input stage comprises first and second transistor devices, each transistor device including a source terminal, a drain terminal and a gate terminal, the source terminals being connected to a third voltage supply, the drain terminals being connected to the latch circuit, the gate terminal of the first transistor device receiving the input signal, and the gate terminal of the second transistor device receiving a logical inversion of the input signal.

13. The circuit of claim 6, wherein the latch circuit comprises first and second transistor devices, each transistor device including a source terminal, a drain terminal and a gate terminal, the source terminals being connected to the second voltage supply, the drain terminals being connected to the input stage, the gate terminal of the first transistor device being connected to the drain terminal of the second transistor device, and the gate terminal of the second transistor device being connected to the drain terminal of the first transistor device.

14. The circuit of claim 6, wherein the latch circuit comprises a differential latch configured such that the signal stored at the output of the latch is a complement of a signal at the input of the latch.

15. The circuit of claim 6, wherein the latch circuit comprises a pair of transistor devices connected in a cross-coupled arrangement.

16. The circuit of claim 6, wherein the voltage clamp comprises first and second transistor devices having the second threshold voltage associated therewith, each transistor device including a source terminal, a drain terminal and a gate terminal, the source terminals being connected to the input stage, the drain terminals being connected to the latch circuit, and the gate terminals of the first and second transistor devices receiving the first control signal.

17. The circuit of claim 6, further comprising an output stage including an input coupled to the output of the latch circuit and an output for generating the output signal of the voltage level translator circuit.

18. The circuit of claim 6, further comprising a transistor device having a source terminal connected to one of the first voltage supply and the second voltage supply, a drain terminal connected to a junction between the voltage clamp and the input stage, and a gate terminal for receiving a second control signal, the transistor device defining the output signal at a known logical state during the first mode of operation.

19. The circuit of claim 6, wherein a nominal voltage level of the first voltage supply is about 1.0 volt and a nominal voltage level of the second voltage supply is about 3.3 volts.

20. An integrated circuit including at least one bias circuit, the at least one bias circuit comprising:
a reference generator for generating a bias signal at an output of the reference generator, the reference generator being selectively operable in one of at least a first mode and a second mode in response to a first control signal applied to the reference generator, wherein in the first mode of operation, the reference generator is disabled, and in the second mode of operation, the reference generator is operative to generate the bias signal; and
a shunt circuit connected to the reference generator, the shunt circuit being configured to provide a source of current to assist in charging the output of the reference generator to a quiescent operating level during the second mode of operation, the shunt circuit, in response to a second control signal applied thereto, being operable for a selected period time after the reference generator transitions from the first mode of operation to the second mode of operation.

21. An integrated circuit including at least one voltage level translator circuit for translating an input signal referenced to a first voltage supply to an output signal referenced to a second voltage supply, the at least one voltage level translator circuit comprising:
an input stage for receiving the input signal, the input stage including at least one transistor device having a first threshold voltage associated therewith;
a latch circuit being operative to store a signal representative of a logical state of the input signal, the latch circuit including at least one transistor device having a second threshold voltage associated therewith, the second threshold voltage being greater than the first threshold voltage;
a voltage clamp operatively connected between the input stage and the latch circuit, the voltage clamp being configured to limit a voltage across the input stage based, at least in part, on a bias signal applied to the voltage clamp; and
a bias circuit, comprising:
a reference generator for generating the bias signal at an output of the reference generator, the reference generator being selectively operable in one of at least a first mode and a second mode in response to a first control signal applied to the reference generator, wherein in the first mode of operation, the reference generator is disabled, and in the second mode of operation, the reference generator is operative to generate the bias signal; and
a shunt circuit connected to the reference generator, the shunt circuit being configured to provide a source of current to assist in charging the output of the reference generator to a quiescent operating level during the second mode of operation, the shunt circuit, in response to a second control signal applied thereto, being operable for a selected period time after the reference generator transitions from the first mode of operation to the second mode of operation.
